(19) United States
(12) Patent Application Publication
(10) Pub. No.: US 2004/0246182 A1
(43) Pub. Date: Dec. 9, 2004

(54) PLANAR INVERTED F ANTENNA WITH ASYMMETRIC OR SYMMETRIC PERTURBATIONS

(76) Inventors: Kuo-Cheng Chen, Tao-Yuan City (TW); Hui-Feng Lee, Tao-Yuan City (TW); Chien-Hua Ma, Tao-Yuan City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,009

(22) Filed: Sep. 1, 2003

(30) Foreign Application Priority Data
Jun. 5, 2003 (TW) 092115295

(51) Int. Cl. H01Q 1/38

(52) U.S. Cl. 343/700 MS

(57) ABSTRACT

An antenna for wireless communication includes a radiator for receiving and transmitting radio frequency (RF) signals comprising a plurality of recesses formed on the sides of the radiator, a feeding plate stretching out from the radiator for transmitting the RF signals, and a ground plate stretching out from the radiator for grounding.

### BACKGROUND OF INVENTION

1. Field of the Invention

The present invention relates to an antenna for wireless communication, and more specifically, to a planar inverted F antenna (PIFA) with asymmetric or symmetric perturbations.

2. Description of the Prior Art

In modern information-oriented society, it is desirable that information is accessible at anytime and at anyplace. Wireless communication equipment is capable of transmitting signals without the use of cables or optical fibers making wireless communication undoubtedly the best way to transmit information. As technology develops, various kinds of wireless communication devices, such as mobile phones and personal digital assistants (PDAs), have become an important means of communicating due to their compactness and portability.

In the field of wireless communication equipment, antennas, which are used to transmit and receive radio waves in order to transfer and exchange data signals, are unquestionably one of the most important devices. Especially in modern portable wireless communication devices, antennas are required to be compact and must be designed to occupy less space in order to match pace with the miniaturization trend of portable wireless devices. In addition, as the bit rate of radio data signals (sometimes measured in units of bits/second) increases, antenna bandwidth requirements increase as well.

Please refer to FIG 1. FIG 1. is a block diagram of a conventional PDA 2. The PDA 2 includes a processing module 3, a liquid crystal display (LCD) 4, a radio frequency (RF) module 5, an antenna 6, a power circuit 7, a universal serial bus (USB) interface 8, and a universal a synchronous receiver/transmitter (UART) 9. The processing module 3 is for controlling data of the PDA 2, the LCD 4 is for displaying an information platform and data of the processing module 3, the RF module 5 is for processing signals from the antenna 6 and the processing module 3, the antenna 6 is for transmitting RF signals, the power circuit 7 provides power to the processing module 3 in order to maintain the operation of the PDA 2, and the USB interface 8 and the UART 9 allow interface to other peripherals for the PDA 2. An RF signal received by the antenna 6 is transmitted at first to the RF module 5 for demodulation, and then the demodulated signal is transmitted to the processing module 3 for data processing. When the RF module 5 receives a signal from the processing module 3, the RF module 5 modulates the signal into an RF signal and radiates the RF signal from the antenna 6 to implement wireless communication.

Concerning the antenna 6 in FIG. 1, please refer to FIG. 2. FIG. 2 illustrates a conventional planar inverted F antenna 10 installed on a circuit board 12. The antenna 10 is a PIFA and includes a radiator 14 for receiving and transmitting RF signals, a feeding plate stretching out of the radiator 14 and connected perpendicularly to a feed pad 18 on the circuit board 18 for transmitting RF signals, and a ground plate 20 stretching out from the radiator 14 and connected perpendicularly to the ground plane 22 on the circuit board 12. The antenna 10 is a single-frequency antenna, which transmits and receives RF signals through the resonance of the radiator 14. The length of the antenna 14 may influence the frequency range for transmission and reception of RF signals.

However, in the conventional antenna 10, the radiator 14 is a conductive strip with straight edges, and its length is approximate quarter the wavelength of the RF signal. Thus, it is a purpose of the present invention to reduce the length of the antenna 10.

### SUMMARY OF INVENTION

It is therefore a primary objective of the present invention to provide a PIFA with asymmetric or symmetric perturbations for the above-mentioned purpose.

Briefly summarized, an antenna for wireless communication includes a radiator for receiving and transmitting radio frequency (RF) signals comprising a plurality of recesses formed on the side of the radiator, a feeding plate stretching out from the radiator for transmitting the RF signals, and a ground plate stretching out from the radiator for grounding.

According to the present invention, an antenna for wireless communication includes a substrate comprising a long side, a short side, and two apertures formed along the short side and penetrating the substrate, a radiator formed for receiving and transmitting RF signals on the upper surface of the substrate comprising a plurality of recesses formed on the side of the radiator, a feeding plate connected to the radiator via the apertures for transmitting the RF signals, a ground plane formed on the lower surface of the substrate, a ground plate connected to the radiator and the ground plane via the apertures, and a trench formed between the feeding plate and the ground plate.

These objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional PDA.

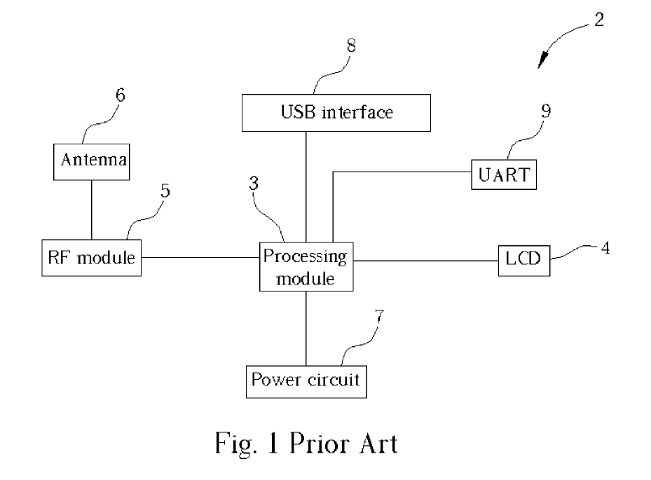

FIG. 2 illustrates a conventional PIFA installed on a circuit board.

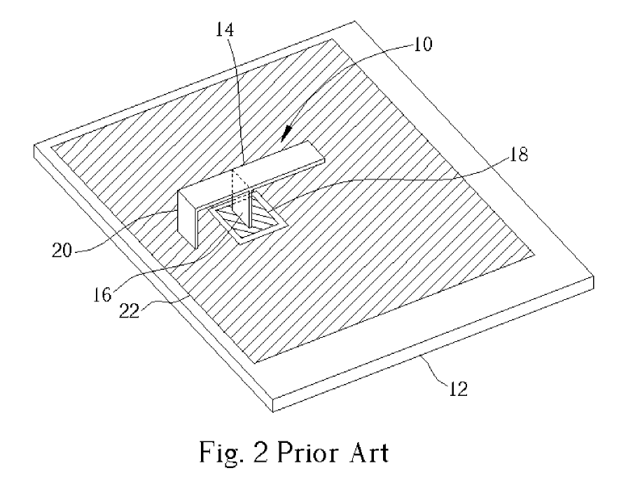

FIG. 3 illustrates a PIFA according to the first embodiment of the present invention.

FIG. 4 illustrates a PIFA according to the second embodiment of the present invention.

FIG. 5 illustrates a PIFA according to the third embodiment of the present invention.

FIG. 6 illustrates a PIFA according to the fourth embodiment of the present invention.

### DETAILED DESCRIPTION

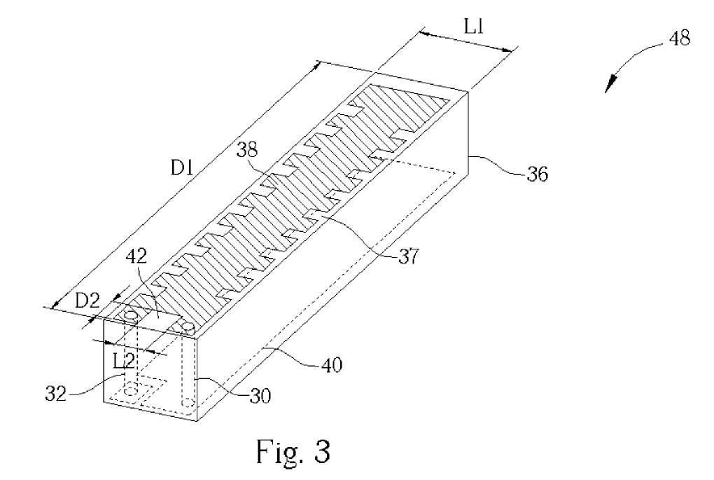

Please refer to FIG. 3 showing a planar inverted F antenna 48 according to the first embodiment of the present invention. In this embodiment, the antenna 48 includes a substrate 36, a ground plate 30, a feeding plate 32, a ground plane 40, and a radiator 38 for receiving and transmitting RF signals. The radiator 38 includes a plurality of recesses 37 and a trench 42. The plurality of recesses 37 is formed on the two side of the radiator 38. The substrate 36 has a long side D1 and a short side L1. The substrate 36 further includes two apertures formed along the short side of the substrate 36 and penetrating the substrate 36. The feeding plate 32 is connected to the radiator 38 via an aperture, so that the radiator 38 transmits RF signals via the feeding plate 32. The ground plate 30 is also connected to the radiator 38 and the ground plane 40 via an aperture.

As shown in FIG. 3, the trench 42 is formed on a side of the radiator 38, and positioned between the ground plate 30 and the feeding plate 32. The width L2 and the length D2 of the trench 42 may influence the impedance matching of the antenna 48, as does the distance between the ground plate 30 and the feeding plate 32.

The plurality of recesses 37 on the two side of the radiator 38 is arranged asymmetrically and periodically for generating periodical perturbation, in order to shorten the resonance length and shorten the length of the antenna 48 as well.

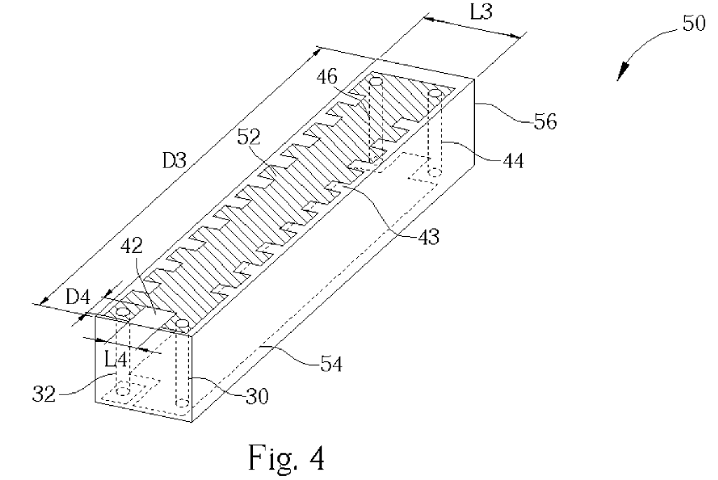

Please refer to FIG. 4 showing a planar inverted F antenna 50 according to the second embodiment of the present invention using the same numbering to that in FIG. 3. The functions of the devices in the second embodiment is essentially the same to the first embodiment, thus a repeated description is hereby omitted. The difference between the two embodiments is that, the antenna 50 further includes two metal apertures 44, 46 for capacitive loading, so that the length of the antenna can be further reduced.

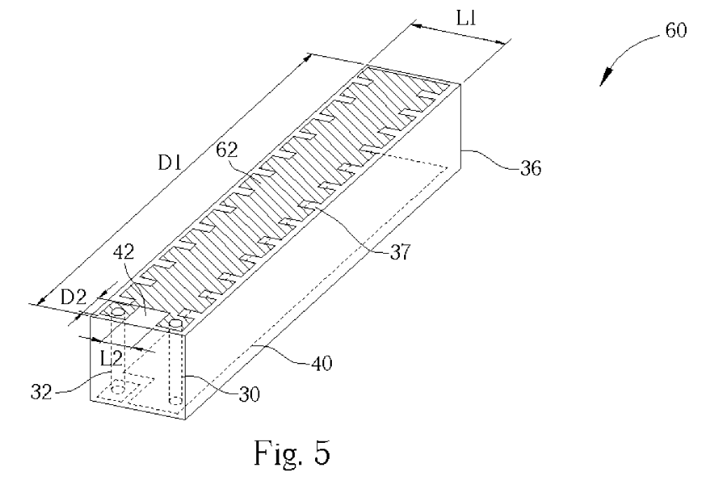

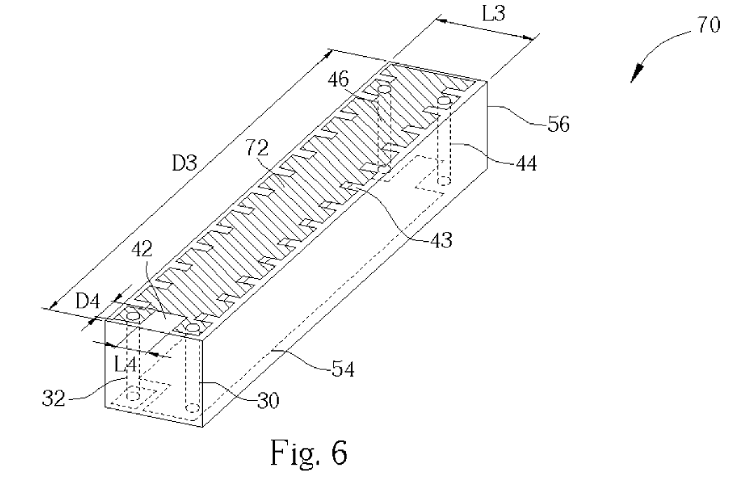

Please refer to FIG. 5 and FIG. 6. FIG. 5 illustrates a planar inverted F antenna 60 according to the third embodiment, and FIG. 6 illustrates a planar inverted F antenna 70 according to the fourth embodiment of the present invention using the same numbering to that in FIG. 3. The functions of the devices in the antenna 60 according to the third embodiment are essentially the same to that in the antenna 48 according to the first embodiment. Similarly, the functions of the devices in the antenna 70 according to the fourth embodiment are essentially the same to that in the antenna 50 according to the second embodiment, thus repeated descriptions are hereby omitted. The difference between the third and the first embodiment, as well as between the fourth and the second embodiment, is that the radiator 62 according to the third embodiment and the radiator 72 according to the fourth embodiment generates periodical perturbation by a plurality of recesses arranged symmetrically and periodically, in order to shorten the resonance length and shorten the length of the radiator as well.

The antennas 48, 50, 60, 70 according to the first, second, third and fourth embodiments respectively all include a substrate. However, this is for example only and an antenna without a substrate can also be used according to the present invention.

In contrast to the prior art, the PIFA according to the present invention generates periodical perturbation using the plurality of recesses arranged asymmetrically and periodically on the two sides of the radiator 38, 52 according to the first and second embodiments or symmetrically and periodically on the two sides of the radiator 62, 72 according to the third and fourth embodiments, so that the resonance length and the length of the radiator can be reduced. Additionally, the length of the antenna can be shortened due to capacitive loading of the two metal apertures 44, 46. Consequently, the present invention shows a more practical and efficient way to utilize an antenna in compact wireless mobile communication devices when compared with a conventional PIFA.

What is claimed is:

1. An antenna for wireless communication comprising:
a radiator for receiving and transmitting radio frequency (RF) signals comprising a plurality of recesses formed on the side of the radiator;
a feeding plate stretching out from the radiator for transmitting the RF signals; and
a ground plate stretching out from the radiator for grounding.

2. The antenna of claim 1 further comprising a substrate, wherein the radiator is formed on the substrate, and the substrate further comprises a plurality of apertures so that the feeding plate and the ground plate penetrate the substrate via the plurality of apertures.

3. The antenna of claim 2 wherein the substrate comprises a long side and a short side, and the feeding plate and the ground plate are installed along the short side.

4. The antenna of claim 1 further comprising a ground plane, wherein the ground plate is connected to the ground plane.

5. The antenna of claim 4 wherein the ground plane is formed on the substrate.

6. The antenna of claim 1 further comprising a trench formed between the feeding plate and the ground plate.

7. The antenna of claim 1 being installed on a printed circuit board.

8. The antenna of claim 1 wherein the plurality of recesses is arranged asymmetrically on the two sides of the radiator.

9. The antenna of claim 1 wherein the plurality of recesses is arranged symmetrically on the two sides of the radiator.

10. The antenna of claim 1 wherein the plurality of recesses is irregular.

11. An antenna for wireless communication comprising:
a substrate having a long side, a short side, and two apertures formed along the short side and penetrating the substrate;
a radiator formed on the upper surface of the substrate for receiving and transmitting RF signals comprising a plurality of recesses formed on the side of the radiator;
a feeding plate connected to the radiator via the apertures for transmitting the RF signals;
a ground plane formed on the lower surface of the substrate;
a ground plate connected to the radiator and the ground plane via the apertures; and
a trench formed between the feeding plate and the ground plate.

12. The antenna of claim 11 being installed on a printed circuit board.

13. The antenna of claim 11 wherein the plurality of recesses is arranged asymmetrically on two side of the radiator.

14. The antenna of claim 11 wherein the plurality of recesses is arranged symmetrically on two side of the radiator.

15. The antenna of claim 11 wherein the plurality of recesses is irregular.
